(19) United States
(12) Patent Application Publication
(10) Pub. No.: US 2008/0235412 A1
(43) Pub. Date: Sep. 25, 2008

(54) MEMORY CONTROLLER WITH BI-DIRECTIONAL BUFFER FOR ACHIEVING HIGH SPEED CAPABILITY AND RELATED METHOD THEREOF

(76) Inventors: Ming-Shiang Lai, Hsin-Chu City (TW); Chung-Hung Tsai, Hsin-Chu Hsien (TW)

Correspondence Address: NORTH AMERICA INTELLECTUAL PROPERTY CORPORATION, P.O. BOX 506, MERRIFIELD, VA, 22116, US

(21) Appl. No.: 12/125,068

(22) Filed: May 22, 2008

Related U.S. Application Data
(63) Continuation of application No. 11/278,547, filed on Apr. 4, 2006.

(51) Int. Cl. G06F 13/00

(52) U.S. Cl. 710/31

(57) ABSTRACT

A memory controller for accessing a serial Flash memory is disclosed. The memory controller includes a logic circuit; a bi-directional buffer, coupled to the logic circuit, for selectively reversing the direction of data flow according to a control signal generated from the logic circuit, the bi-directional buffer comprising: an input port, coupled to a data output port of the logic circuit; a control port, coupled to the logic circuit, for receiving the control signal; and an output port, coupled to a data input port of the logic circuit, the output port being utilized for coupling both an input data port and an output data port of the serial Flash memory.

### CROSS REFERENCE TO RELATED APPLICATIONS

This is a continuation of application Ser. No. 11/278,547, filed Apr. 4, 2006, from which the specification and drawings are carried forward without amendment.

### BACKGROUND

Flash memories are non-volatile memories, i.e. they can retain their data even if their power supply is removed. In this respect they have significant advantages over volatile memories such as SRAM and DRAM.

Conventional processors mostly utilize a memory controller that can access a parallel Flash memory by means of an interface for carrying signals. The parallel Flash has the disadvantage, however, of a large number of pin connections. Serial Flash connectivity greatly reduces the number of signals to the memory controller. For example, an SPI bus for serial Flash memories only requires a memory controller to handle 4 signals (data in, data out, clock, and chip enable) whereas interfacing a 10-bit address parallel Flash would require the memory controller to receive 21 signals. Serial Flash memories can therefore fit into smaller and less expensive packages.

Traffic between a serial Flash and a memory controller is in two stages. The first stage is a Command stage whereby addresses and commands are input to a data input pin. The second stage is a data in/out stage wherein data is sent between the serial FLASH memory and the memory controller.

### SUMMARY

It is one of the objectives of the present disclosure to further reduce the number of pin connections of a memory controller by providing a memory controller that has an output port coupled to both a data input port and a data output port of a serial Flash memory.

Briefly described, the invention comprises a memory controller for accessing a serial Flash memory, the memory controller comprising: a logic circuit; a bi-directional buffer, coupled to the logic circuit, for selectively reversing the direction of data flow according to a control signal generated from the logic circuit, the bi-directional buffer comprising: an input port, coupled to a data output port of the logic circuit; a control port, coupled to the logic circuit, for receiving the control signal; and an output port, coupled to a data input port of the logic circuit, the output port being utilized for coupling both an input data port and an output data port of the serial Flash memory.

A method for accessing a serial Flash memory by a memory controller is further provided. The method comprises: providing a logic circuit for controlling data access of the first serial Flash memory, wherein the logic circuit comprises a first data output port and a first data input port; providing a first bi-directional buffer, wherein the first bi-directional buffer comprises an input port, a control port, and an output port; coupling the input port and the output port to the first data output port and the first data input port, respectively; and selectively reversing the direction of data flow by transmitting a control signal to the control port of the first bi-directional buffer.

The present invention also provides various embodiments of a turnaround controller for controlling the timing of data operations, and related methods for delaying the time between data in and data out operations. A preferred embodiment of the turnaround controller comprises: a tunable delay chain, connected to the logic circuit, for receiving the control signal and outputting a first delayed control signal; a flip-flop, connected to the logic circuit, for receiving the control signal and outputting a second delayed control signal, wherein the flip-flop and the logic circuits are triggered by different edges of a reference clock; and a multiplexer, connected to the flip-flop, the tunable delay chain, and the logic circuit, for receiving a selection signal from the logic circuit, the first delayed control signal and the second delayed control signal, and outputting a resultant control signal to the first bi-directional buffer from the first delayed control signal and the second delayed control signal according to the selection signal.

A second preferred embodiment of the turnaround controller comprises: a flip-flop, connected to the logic circuit, for receiving the control signal and outputting a delayed control signal, wherein the flip-flop and the logic circuits are triggered by different edges of a reference clock; a multiplexer, connected to the flip-flop and the logic circuit, for receiving the delayed control signal, the control signal, and a selection signal from the logic circuit, and outputting a resultant control signal from the delayed control signal and the control signal according to the selection signal; and a tunable delay chain, connected to the multiplexer, for receiving the resultant control signal, delaying the resultant control signal, and outputting a delayed resultant control signal to the first bi-directional buffer.

A preferred method for delaying the time between data in and data out operations between a memory controller and a serial FLASH memory comprises: delaying the control signal received from the control logic to generate a first delayed control signal; delaying the control signal received from the control logic to generate a second delayed control signal; and multiplexing the first and second delayed control signals to output a resultant control signal to the bi-directional buffer.

A second preferred method for delaying the time between data in and data out operations between a memory controller and a serial FLASH memory comprises: delaying the control signal received from the control logic to generate a delayed control signal; multiplexing the control signal received from the control logic and the delayed control signal to output a resultant control signal; and delaying the resultant control signal to output a delayed resultant control signal to the bi-directional buffer.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a first embodiment of a memory controller according to the present invention.

FIG. 2 is a diagram illustrating a second embodiment of the memory controller.

FIG. 3 is a diagram illustrating a third embodiment of the memory controller.

FIG. 4 is a diagram illustrating a fourth embodiment of the memory controller.

FIG. 5 is a diagram illustrating a fifth embodiment of the memory controller.

FIG. 6 is a diagram illustrating a sixth embodiment of the memory controller.

FIG. 7 is a diagram of a first cascode architecture of the present invention.

FIG. 8 is a diagram of a second cascode architecture of the present invention.

FIG. 9 is a diagram of a third cascode architecture of the present invention.

### DETAILED DESCRIPTION

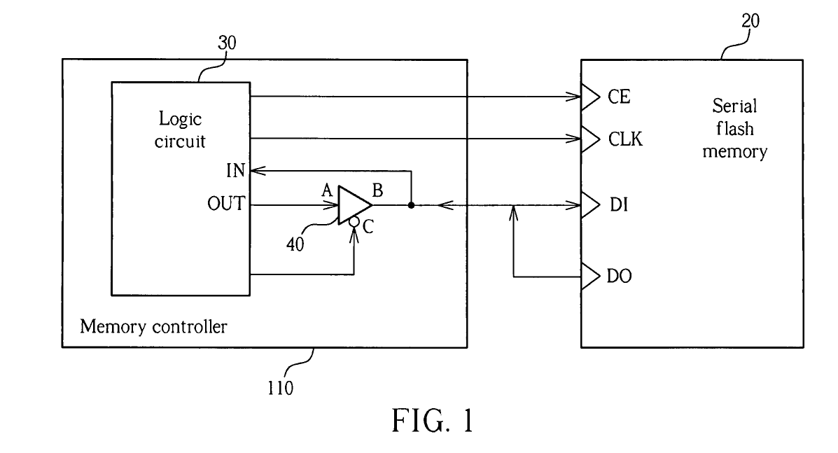

Please refer to FIG. 1. FIG. 1 is a diagram illustrating a first embodiment of a memory controller 110 according to the present invention. The memory controller 110 is for accessing a first serial FLASH memory 20 utilizing an SPI bus that has four signals: namely, data in (DI), data out (DO), chip enable (CE), and clock (CLK). The memory controller 110 contains a logic circuit 30 that is coupled to the first serial Flash memory 20 by means of the SPI bus. The memory controller 110 further comprises a bi-directional buffer 40, the bi-directional buffer 40 having an input port A, coupled to a first data output port OUT of the logic circuit 30; a control port C, coupled to the logic circuit 30, for receiving a control signal; and an output port B, coupled to a first data input port IN of the logic circuit 30, the output port B being utilized for coupling both an input data port (i.e. DI) and an output data port (i.e. DO) of the first serial Flash memory 20. In this embodiment the bi-directional buffer 40 is realized by a tri-state buffer. Please note this is merely one embodiment and is not a limitation.

The utilization of the tri-state buffer 40 enables data to be both sent and received by the memory controller 10 while utilizing only one pin connection. The operation of the tri-state buffer 40 will be described herein. As mentioned above, the tri-state buffer 40 has an input port A, a control port C, and an output port B. When an active control signal is input to the control port C, the output of the tri-state buffer 40 follows the input. In this case, data from the memory controller 110 will be sent to the first serial Flash memory 20. When the control signal input to the control port C is not active, the output will be “Z”. This is a state of high impedance, meaning that no electrical current will flow. In other words, whatever value is input to the input port, that value will not be output. In this situation, data transmitted from the first serial Flash memory 20 can be received by the memory controller 110.

When the control signal is changed from inactive to active or vice-versa, there will be a delay between data being sent and data being received. The control signal is transmitted to the tri-state buffer 40 on a rising or a falling edge of a clock generated by the logic circuit 30. The rising edge of the clock, in this embodiment, also dictates when data is transmitted. When this occurs, the data signal requires some time to stabilize, and this can interrupt the transmission of a first packet of data. To solve this turnaround problem, therefore, either the control signal or the clock signal needs to be delayed, allowing the signal time to stabilize and a complete packet of data to be sent.

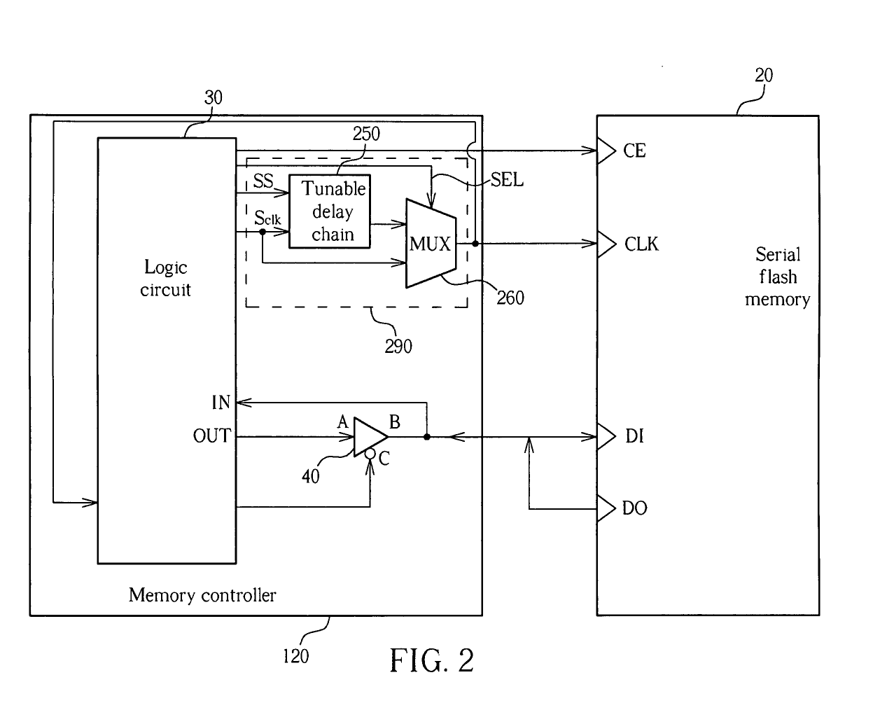

To solve this turnaround problem, various methods and apparatuses for adjusting the control signal or the clock signal are disclosed. A first method adjusts the control signal by utilizing a tunable delay chain coupled to the logic circuit 30. Please refer to FIG. 2. FIG. 2 is a diagram of a second embodiment of the memory controller 120. The memory controller further comprises a turnaround controller 290, comprising a tunable delay chain 250, and a multiplexer (MUX) 260. The tunable delay chain 250 consists of a plurality of delay buffers connected in series (not shown), where the outputs of the plurality of delay buffers are connected in parallel to a multiplexer (not shown). The tunable delay chain 250 receives a clock signal Sclk from the logic circuit 30. A selection signal SS from the logic circuit 30 is also input to the tunable delay chain 250, containing information related to the required delay time. In this way, the tunable delay chain 250 can output a clock signal that is delayed by a required amount of time. The clock signal Sclk is also input to the multiplexer 260, which further receives the delayed clock signal from the tunable delay chain 250 and a selection signal SEL from the logic circuit 30. The multiplexer 260 will then output a resultant clock signal to the serial Flash memory 20.

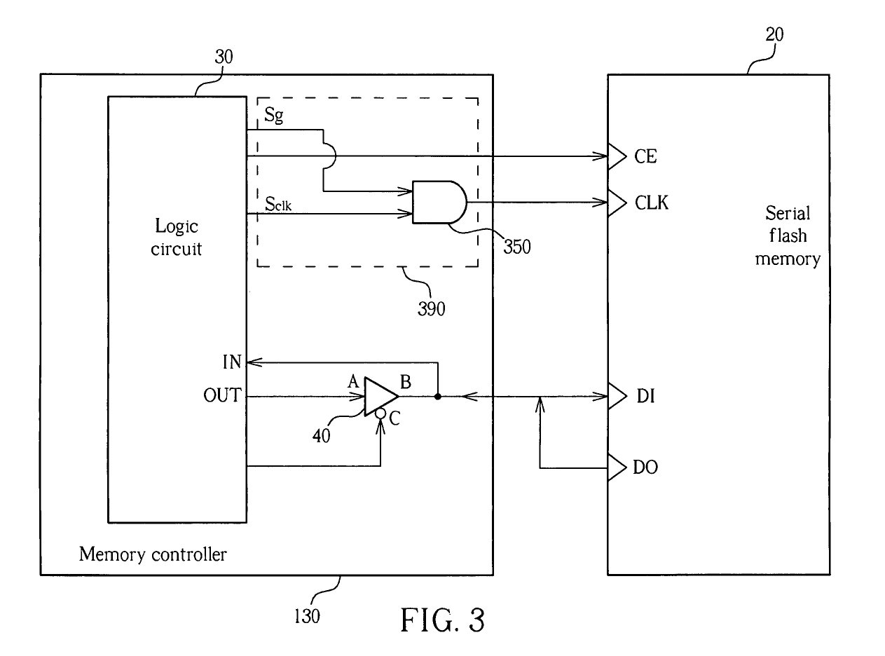

A second method utilizes a clock gating mechanism to gate the clock, for example, for one cycle, thereby allowing the signal time to stabilize. Please refer to FIG. 3. FIG. 3 is a diagram of a third embodiment of the memory controller 130. The memory controller 130 further comprises a turnaround controller 390, comprising a clock gating unit 350 coupled to a clock output port of the logic circuit 30, for receiving a clock signal Sclk, and further coupled to a clock gating control signal Sg. When the clock gating control signal Sg is briefly switched from ‘high’ to ‘low’ and then back again, the first clock cycle will be shortened.

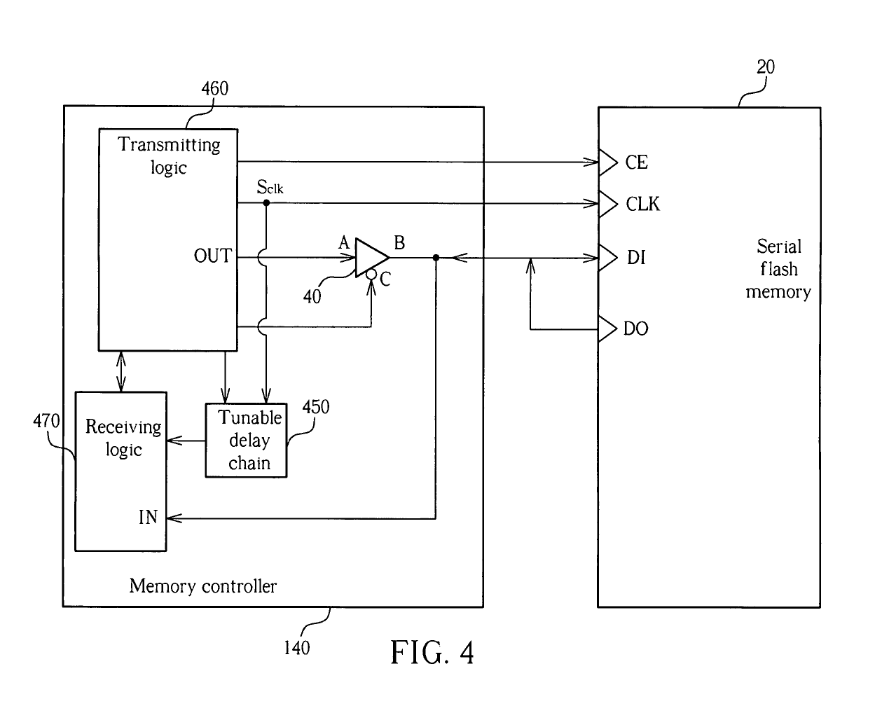

Please refer to FIG. 4. FIG. 4 is a diagram of a fourth embodiment of the memory controller 140. The memory controller 140 further comprises a data transmitting logic 460, having a first data output port OUT coupled to the bi-directional buffer 40, and a data receiving logic 470, having a first data input port IN coupled to a tunable delay chain 450. The tunable delay chain 450 receives a clock signal Sclk from the transmitting logic 460, and inputs a delayed clock signal to the receiving logic 470.

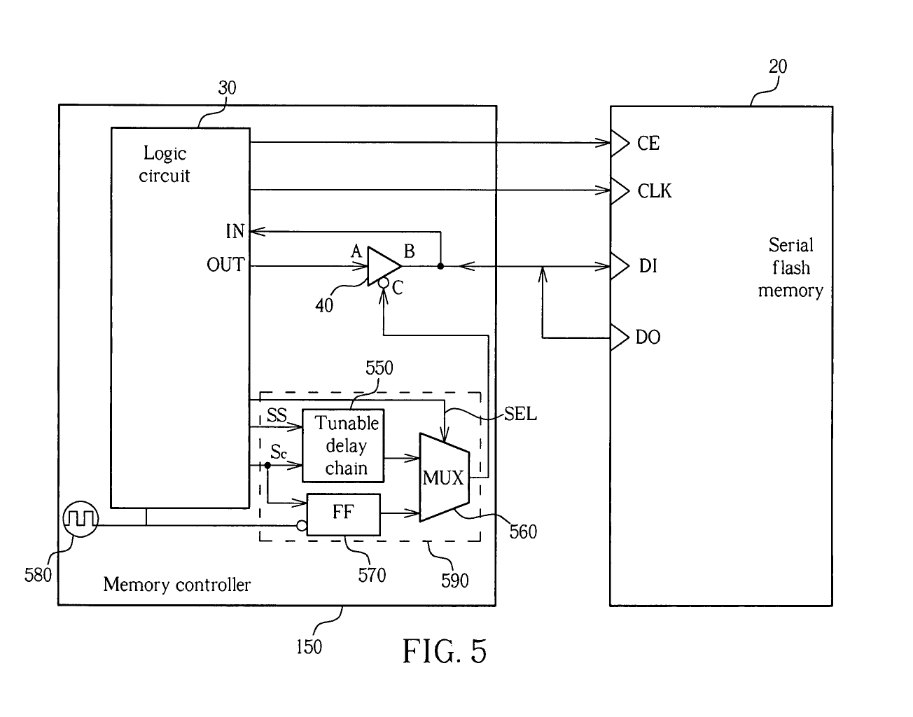

Please refer to FIG. 5. FIG. 5 is a diagram of a fifth embodiment of the memory controller 150. The memory controller 150 further includes a turnaround controller 590. The turnaround controller 590 comprises a tunable delay chain 550, a multiplexer (MUX) 560, and a buffer 570. In FIG. 5 the buffer 570 is implemented by a flip-flop; please note this is merely one embodiment of the turnaround controller 590, and other components having the same delay function as the flip-flop may be utilized. The tunable delay chain 550 consists of a plurality of delay buffers (not shown) connected in series, with their outputs connected in parallel to a multiplexer (not shown). The tunable delay chain 550 receives a control signal Sc from the logic circuit 30, and outputs a first delayed control signal according to a selection signal SS used to control the multiplexer inside the tunable delay chain 550. Since the function and operation of the tunable delay chain 550 are well-known to those skilled in this art, further description is omitted. The flip-flop 570 is connected to the logic circuit 30. The flip-flop 570 is triggered by a reference clock 580 and outputs a second delayed control signal. It should be noted that the flip-flop 570 and the logic circuit 30 are triggered by different edges of the reference clock 580. For example, the logic circuit 30 is a rising-edge-triggered component, while the flip-flip 570 is a falling-edge-triggered component. The first delayed control signal and the second delayed input signal are input to the multiplexer 560. The multiplexer's third input is a selection signal SEL from the logic circuit 30. The selection signal SEL contains information relating to a desired delay time of the control input signal. The multiplexer 560 utilizes the selection signal SEL to select a resultant control signal. The output of the multiplexer 560 is sent to the first bi-directional buffer 40. In this way, the control input signal can be delayed as desired.

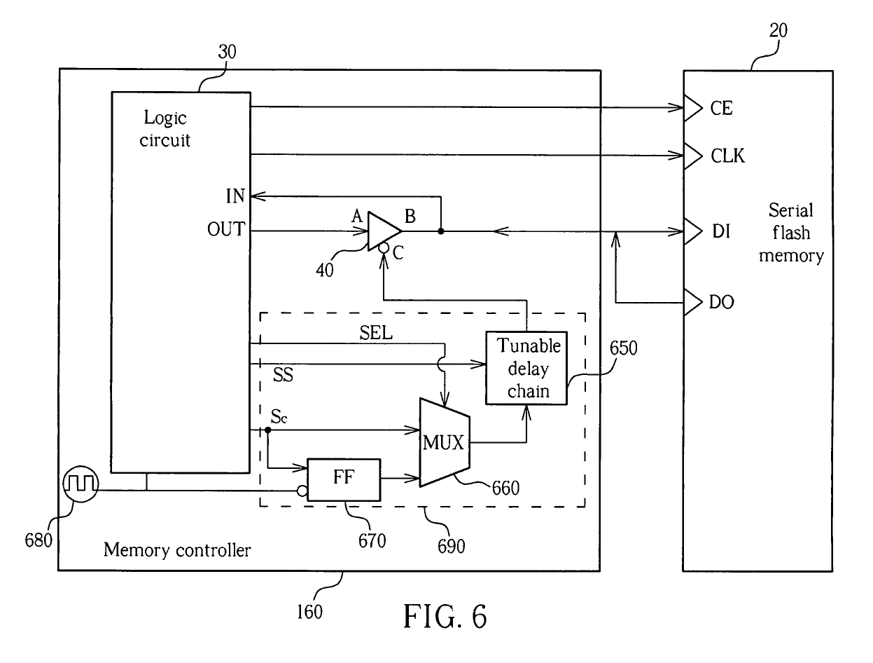

Please refer to FIG. 6. FIG. 6 is a diagram illustrating a sixth embodiment of the memory controller 10. Similarly, this sixth embodiment includes a turnaround controller 690. As can be seen from FIG. 6, the components of the turnaround controller are the same as the components of the turnaround controller 590 but the architecture is different. To avoid confusion, the components of the turnaround controller 690 in this embodiment are given different figure numerals. Please note that these numerals do not represent a difference in function between the components of FIG. 5 and the components of FIG. 6. In FIG. 6 the flip-flop 670 receives a control signal Sc from the logic circuit 30 and outputs a delayed control signal, wherein the flip-flop 670 and the logic circuit 30 are triggered by different edges of a reference clock 680. The multiplexer 660 receives the control signal Sc, the delayed control signal, and a selection signal SEL, and outputs a resultant control signal accordingly. The tunable delay chain 650 receives the resultant control signal from the multiplexer 660, delays the resultant control signal, and outputs a delayed resultant control signal to the first bi-directional buffer 40 according to a selection signal SS used to control the multiplexer inside the tunable delay chain 650.

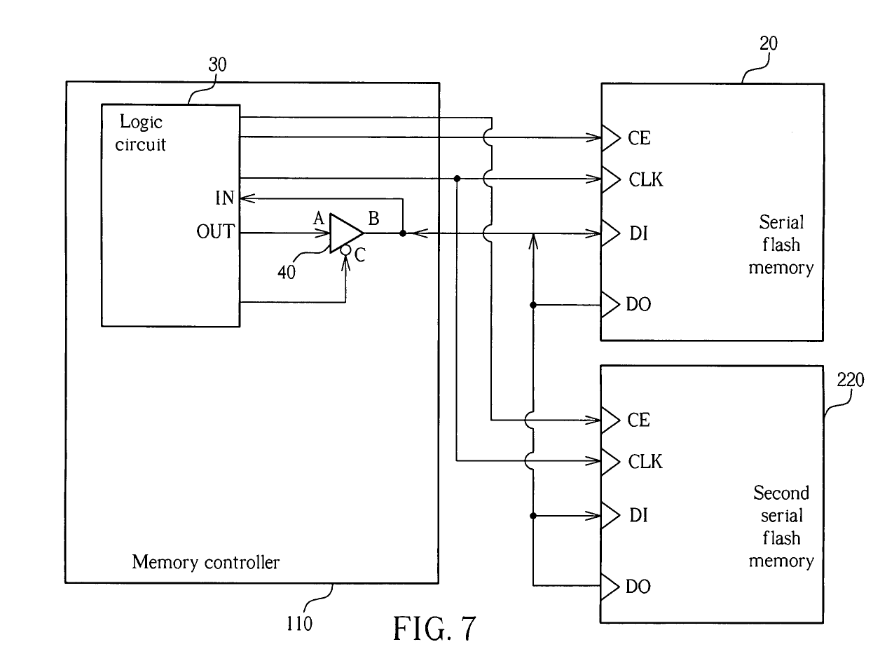

The coupling of the output port to both an input data port and an output data port of the first serial Flash memory 20 also enables a second serial Flash memory 220 to be coupled to the memory controller 110, while still maintaining a reduced number of pin connections, and thereby meeting the aims and objectives of the present disclosure. Please refer to FIG. 7. FIG. 7 is a diagram of a first cascode form of the present invention. The output port of the memory controller 110 is coupled to a data input port and a data output port of a second serial Flash memory 220. A second chip enable pin connection is added to the memory controller 110, and coupled to an input port of the second serial Flash memory 220. The clock output port of the memory controller 110 is coupled to both the first serial Flash memory 20 and the second serial Flash memory 220. As the data output pin is in tri-state when no control signal exists, many serial Flash memories can share the same connection.

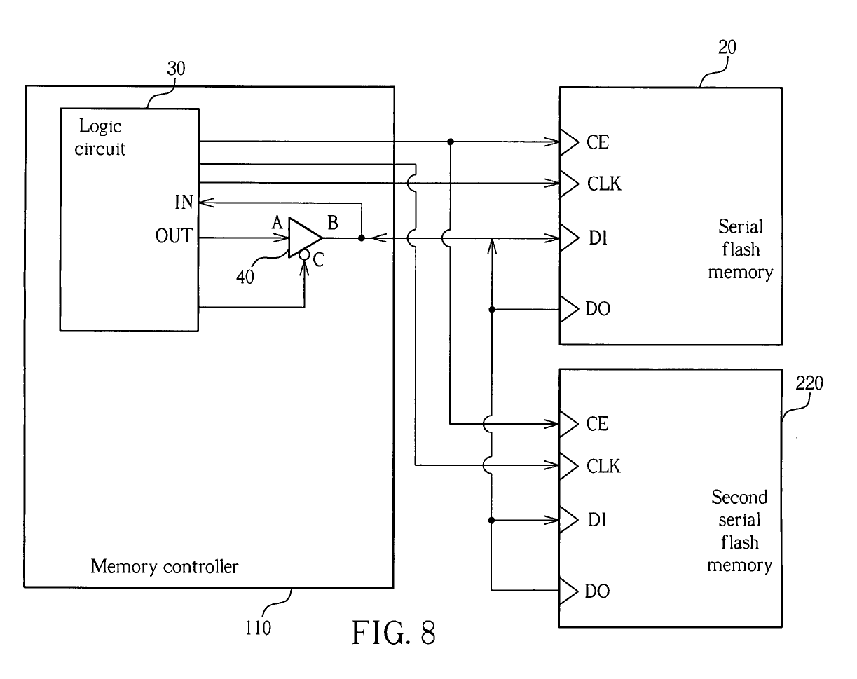

The data output pin is in tri-state until incoming commands are received. Therefore another cascode architecture can also be implemented. Please refer to FIG. 8. FIG. 8 is a diagram of a second cascode architecture. In this architecture the memory controller 110 only has one chip enable pin, which is coupled to both the first serial Flash memory 20 and the second serial Flash memory 220. The key difference in this embodiment is that the memory controller 110 comprises a second clock output port coupled to the second serial Flash memory 220. The output port of the memory controller 110 is still coupled to a data input port and a data output port of the second serial Flash memory 220, and a data input port and a data output port of the first serial Flash memory 20.

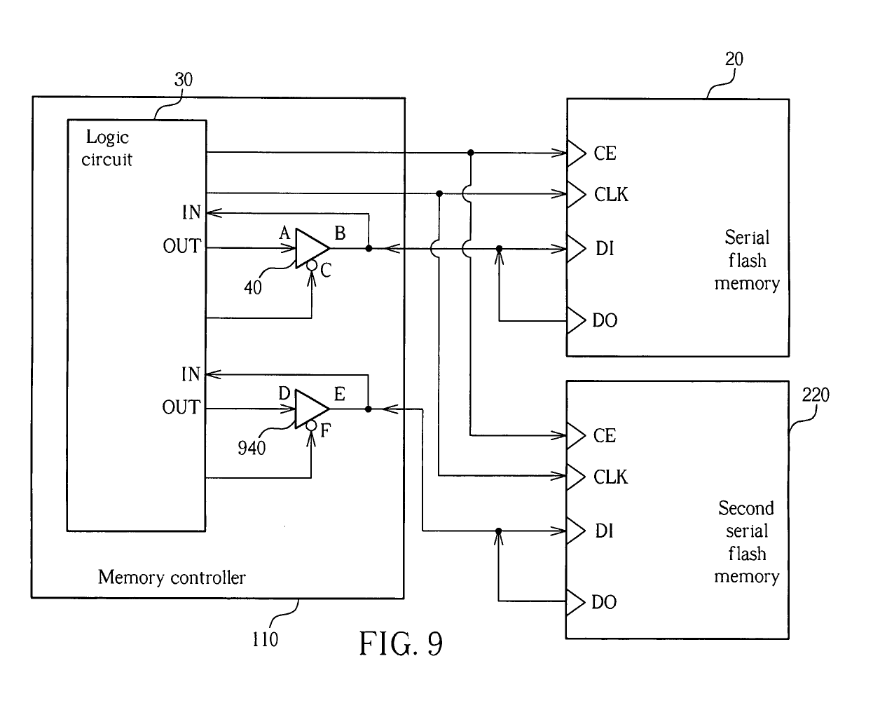

In FIG. 7 and FIG. 8 the first serial Flash memory 20 and the second serial Flash memory 220 are coupled to the data output port of the logic circuit 30. Please refer to FIG. 9. FIG. 9 is a diagram of a third cascode architecture of the present invention. In this architecture, the memory controller 110 further comprises a second bi-directional buffer 940, having an input port D coupled to a second data output port of the logic circuit 30, a control port F coupled to the control port of the first bi-directional buffer 40, and an output port E coupled to a second input port of the logic circuit 30. The clock output port of the memory controller 110 is coupled to a clock input port of the second serial Flash memory 220, and the chip enable port of the memory controller 110 is coupled to a chip enable input port of the second serial Flash memory 220. Please note that the clock output port and the chip enable port of the memory controller 110 are also respectively coupled to a clock input port and a chip enable input port of the first serial Flash memory 20.

It is an advantage of the present disclosure that the memory controller can access a serial Flash memory utilizing a reduced number of pins. It is a further advantage that the memory controller can be implemented with a cascode architecture. Furthermore, the utilization of the turnaround controller can ensure that when the data operation changes direction all data will be correctly transmitted.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A memory controller for accessing a serial Flash memory, the memory controller comprising:
a logic circuit;
a bi-directional buffer, coupled to the logic circuit, for selectively reversing the direction of data flow according to a control signal generated from the logic circuit, the bi-directional buffer comprising:
an input port, coupled to a first data output port of the logic circuit;
a control port, coupled to the logic circuit, for receiving the control signal; and
an output port, coupled to a first data input port of the logic circuit, the output port being utilized for coupling both an input data port and an output data port of the serial Flash memory; and
a turnaround controller, coupled to at least one of the control signal, a clock signal and the bi-directional buffer for creating a delay when the direction of data flow is reversed.

2. The memory controller of claim 1, wherein the bi-directional buffer is a tri-state buffer.

3. The memory controller of claim 1, wherein the turnaround controller is coupled to the logic circuit and the control port of the bi-directional buffer, for controlling timing of the control signal.

4. The memory controller of claim 3, wherein the turnaround controller comprises:
a tunable delay chain, connected to the logic circuit, for receiving the control signal and outputting a first delayed control signal;
a flip-flop, connected to the logic circuit, for receiving the control signal and outputting a second delayed control signal, wherein the flip-flop and the logic circuits are triggered by different edges of a reference clock; and
a multiplexer, connected to the flip-flop, the tunable delay chain, and the logic circuit, for receiving a selection signal from the logic circuit, the first delayed control signal and the second delayed control signal, and outputting a resultant control signal to the bi-directional buffer from the first delayed control signal and the second delayed control signal according to the selection signal.

5. The memory controller of claim 3, wherein the turnaround controller comprises:
a flip-flop, connected to the logic circuit, for receiving the control signal and outputting a delayed control signal, wherein the flip-flop and the logic circuits are triggered by different edges of a reference clock;
a multiplexer, connected to the flip-flop and the logic circuit, for receiving the delayed control signal, the control signal, and a selection signal from the logic circuit, and outputting a resultant control signal from the delayed control signal and the control signal according to the selection signal; and
a tunable delay chain, connected to the multiplexer, for receiving the resultant control signal, delaying the resultant control signal, and outputting a delayed resultant control signal to the bi-directional buffer.

6. The memory controller of claim 1, wherein the turnaround controller is coupled to a clock output port of the logic circuit, for controlling timing of the clock signal outputted to the serial Flash memory.

7. The memory controller of claim 6, wherein the turnaround controller comprises:
a clock-gating unit, for selectively gating the clock signal according to a clock-gating control signal generated from the logic circuit.

8. The memory controller of claim 6, wherein the turnaround controller comprises:
a tunable delay chain, for receiving the clock signal and outputting a delayed clock signal; and
a multiplexer, coupled to the tunable delay chain and the clock output port of the logic circuit, for receiving the delayed clock signal, the clock signal, and a selection signal from the logic circuit, and outputting a resultant clock signal from the delayed clock signal and the clock signal according to the selection signal.

9. The memory controller of claim 1, wherein the logic circuit comprises a data transmitting logic coupled to the first data output port of the logic circuit and a data receiving logic coupled to the first data input port of the logic circuit, and the turnaround controller is a tunable delay chain, coupled to a clock output port of the logic circuit and the data receiving logic, for receiving the clock signal outputted to the serial Flash memory and outputting a delayed clock signal to drive the data receiving logic.

10. A method for accessing a serial Flash memory, the method comprising:
providing a logic circuit for controlling data access of the serial Flash memory, wherein the logic circuit comprises a first data output port and a first data input port;
providing a bi-directional buffer, wherein the bi-directional buffer comprises an input port, a control port, and an output port;
coupling the input port and the output port to the first data output port and the first data input port, respectively;
selectively reversing the direction of data flow by transmitting a control signal to the control port of the bi-directional buffer; and
generating a delay when the direction of data flow is reversed.

11. The method of claim 10, wherein the step of generating a delay when the direction of data flow is reversed comprises:
delaying the control signal received from the logic circuit to generate a first delayed control signal;
delaying the control signal received from the logic circuit to generate a second delayed control signal; and
multiplexing the first and second delayed control signals to output a resultant control signal to the bi-directional buffer.

12. The method of claim 10, wherein the step of generating a delay when the direction of data flow is reversed comprises:
delaying the control signal received from the logic circuit to generate a delayed control signal;
multiplexing the control signal received from the logic circuit and the delayed control signal to output a resultant control signal; and
delaying the resultant control signal to output a delayed resultant control signal to the bi-directional buffer.

13. The method of claim 10, wherein the logic circuit further comprises a clock output port for outputting a clock signal to the serial Flash memory, and the step of generating a delay when the direction of data flow is reversed comprises:
selectively gating the clock signal.

14. The method of claim 10, wherein the logic circuit further comprises a clock output port for outputting a clock signal to the serial Flash memory, and the step of generating a delay when the direction of data flow is reversed further comprises:
delaying the clock signal received from the logic circuit to generate a delayed clock signal;
multiplexing the clock signal received from the logic circuit and the delayed clock signal to output a resultant clock signal.

15. The method of claim 10, wherein the logic circuit comprises a data transmitting logic coupled to the first data output port of the logic circuit and a data receiving logic coupled to the first data input port of the logic circuit, and the step of generating a delay when the direction of data flow is reversed further comprises:
receiving a clock signal outputted to the serial Flash memory by the logic circuit; and
delaying the clock signal to output a delayed clock signal to drive the data receiving logic.
